(19) United States
(12) Patent Application Publication
(10) Pub. No.: US 2005/0237749 A1
(43) Pub. Date: Oct. 27, 2005

(54) Transflector

(75) Inventors: Kenneth A. Epstein, Saint Paul, MN (US); Keith M. Kotchick, Saint Paul, MN (US); Patrick H. Marushin, Saint Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/829,566

(22) Filed: Apr. 22, 2004

(51) Int. Cl. F21V 5/00; F21V 7/04

(52) U.S. Cl. 362/330; 362/610; 362/616

(57) ABSTRACT

Transflectors are disclosed that include a body having a first surface and a second surface, the second surface being a structured surface that includes prismatic structures having first and second facets. The transflector body is configured so that, in a reflective mode, light incident onto the first surface at a reflected incident angle is refracted through the first surface, reflected at the first facet of a first prismatic structure, reflected at the second facet of a second prismatic structure, and refracted through the first surface with a maximum intensity at about a reflected exit angle. The transflector body is also configured so that, in a transmissive mode, light incident onto the second surface at a transmitted incident angle is directed by a prismatic structure to the first surface and refracted through the first surface with a maximum intensity at about a transmitted exit angle. Also disclosed are methods of making, as well as display devices incorporating such transflectors.

### FIELD OF THE INVENTION

The present invention relates to transflectors, and, more particularly, to optical components that reflect light incident on one of their surfaces within a range of incident ray angles and also transmit light incident on another surface within a different range of incident ray angles.

### BACKGROUND

Microprocessor-based devices that include electronic displays for conveying information to a viewer have become nearly ubiquitous. Mobile phones, handheld computers, personal digital assistants, electronic games, car stereos and indicators, public displays, automated teller machines, in-store kiosks, home appliances, computer monitors, and others are all examples of devices that include information displays viewed on a daily basis. Many of the displays provided on such devices are liquid crystal displays (“LCDs”).

Unlike cathode ray tube (CRT) displays, LCDs do not emit light and, thus, require a separate light source for viewing images formed on such displays. Ambient light illumination is sufficient for some applications, but with many LCDs, such as most large area and high performance LCDs, ambient light causes glare and is detrimental to readability. On the other hand, some applications require display viewing under the conditions where ambient illumination is not present or its intensity is insufficient. Thus, in order to improve readability, some LCDs include a source of light located behind the display, which is generally known as “backlight.”

LCDs that may be viewed with ambient illumination as well as with backlight illumination are generally known as “transflective” displays. Examples of currently available transflectors include partial mirror transflectors and transflectors utilizing reflective polarizers. Transflectors utilizing reflective polarizers typically have relatively high brightness, but their output usually is characterized by rotation of the image by 180 degrees (image inversion). Partial mirror transflectors do not exhibit image inversion, but their output brightness is lower. Typical currently available transflectors also require a tradeoff between output brightness in transmission mode versus output brightness in reflection mode.

Transflective LCDs usually include a layer of a liquid crystal material placed between two polarizers. The first polarizer ensures that light is provided to the liquid crystal layer in the appropriate polarization state, the liquid crystal material selectively alters the polarization state of the light, and the second polarizer analyzes the light. In particular, the second polarizer transmits light with the polarization state that is aligned with its transmission axis, thereby generating a bright spot. Light that is transmitted to the front polarizer with a polarization state that is not aligned with the transmission axis of the front polarizer is at least partially blocked by the front polarizer, thereby generating a darker spot. Each such spot is generally referred to as a pixel. Taken together, pixels form an image that can convey information to a viewer.

Due to low transmission of typical LCDs, power conservation and reduction of power consumption are important concerns in designing LCDs and their backlights. Efficient use of light is particularly important in battery-powered electronic displays, such as those used in cell phones, personal digital assistants, and laptop computers. In these and similar applications, battery lifetime is usually carefully balanced against the battery size and the overall size of the device. By improving lighting efficiency, battery life can be increased and/or battery size can be reduced. Thus, there is an ongoing need for more efficient optical components, which may be used in LCDs, so that their power consumption may be reduced.

### BRIEF SUMMARY OF THE INVENTION

The present disclosure is directed to transflectors having a first surface and a second surface. The second surface is a structured surface that includes prismatic structures having first and second facets. The transflector is configured so that, in a reflective mode, light incident onto the first surface at a reflected incident angle is refracted through the first surface, reflected at the first facet of a first prismatic structure, reflected at the second facet of a second prismatic structure, and refracted through the first surface with a maximum intensity at about a reflected exit angle. In a transmissive mode, light incident onto the second surface at a transmitted incident angle is directed by a prismatic structure to the first surface and refracted through the first surface with a maximum intensity at about a transmitted exit angle.

The present disclosure is also directed to display modules including a transmissive image-forming device, a backlight, and a transflector having a first surface and a second surface. The second surface is a structured surface that includes prismatic structures having first and second facets. The transflector is disposed between the image-forming device and the backlight so that the first surface faces the image-forming device and the second surface faces the backlight. The transflector is configured so that, in a reflective mode, light transmitted through the image-forming device at and incident onto the first surface at a reflected incident angle is refracted through the first surface, reflected at the first facet of a first prismatic structure, reflected at the second facet of a second prismatic structure, refracted through the first surface, and transmitted through the image-forming device with a maximum intensity at about a reflected exit angle. In a transmissive mode, light originating from the backlight and incident onto the second surface at a transmitted incident angle is directed by a prismatic structure to the first surface, refracted through the first surface, and transmitted through the image-forming device with a maximum intensity at about a transmitted angle.

The present disclosure is also directed to methods of making transflectors, which include the steps of selecting a reflected incident angle, selecting a transmitted incident angle; selecting a reflected exit angle, selecting a transmitted exit angle, and configuring a transflector body having a first surface and a second surface, the second surface being a structured surface including prismatic structures. The transflector body is configured so that, in a reflective mode, light incident onto the first surface at the reflected incident angle is refracted through the first surface to a first prismatic structure, directed by the first prismatic structure to a second prismatic structure, directed by the second prismatic structure to the first surface, and refracted through the first surface with a maximum intensity at about the reflected exit angle. In a transmissive mode, light incident onto the second surface at the transmitted incident angle is directed by a prismatic structure to the first surface and refracted through the first surface with a maximum intensity at about the transmitted exit angle.

These and other aspects of the transflectors and display modules constructed according to the subject invention will become readily apparent to those of ordinary skill in the art from the following detailed description together with the drawings.

### BRIEF DESCRIPTION OF THE DRAWINGS

So that those of ordinary skill in the art to which the subject invention pertains will more readily understand how to make and use the subject invention, exemplary embodiments thereof will be described in detail below with reference to the drawings, wherein:

FIG. 1 is a partial cross-sectional view of an exemplary prismatic transflector constructed according to the present disclosure, illustrating its operation in a reflective mode;

FIG. 2 is a partial cross-sectional view of an exemplary prismatic transflector constructed according to the present disclosure, illustrating its operation in a transmissive mode;

FIG. 3 is a schematic cross-sectional view of a display module, which includes an exemplary transflector constructed according to the present disclosure;

FIG. 4 is a plot of the reflected exit angle αₑ against the facet angle f1 for each of several facet angles f0 (27, 30, 33, 35, 38, 40 and 42 degrees), where the incident reflected angle αᵢ is set to about 30 degrees and the refractive index n of the transflector body is set to about 1.6;

FIG. 5A shows facet angle pairs, for which the TIR condition is satisfied, where the reflected incident angle is about 30 degrees and the transflector body refractive index n is set to about 1.4;

FIG. 5B shows facet angle pairs, for which the TIR condition is satisfied, where the reflected incident angle is about 30 degrees and the transflector body refractive index n is set to about 1.5;

FIG. 5C shows facet angle pairs, for which the TIR condition is satisfied, where the reflected incident angle is about 30 degrees and the transflector body refractive index n is set to about 1.6;

FIG. 5D shows facet angle pairs, for which the TIR condition is satisfied, where the reflected incident angle is about 30 degrees and the transflector body refractive index n is set to about 1.7;

FIG. 6A shows facet angle pairs, for which a ray directed by a first prismatic structure intersects the second facet of a second prismatic structure, where the transmitted incident angle is about 30 degrees and the transflector body refractive index n is about 1.5;

FIG. 6B shows facet angle pairs, for which a ray directed by a first prismatic structure intersects the second facet of a second prismatic structure, where the transmitted incident angle is about 30 degrees and the transflector body refractive index n is about 1.6;

FIG. 7 is a plot of the transmitted exit angle βₑ against the facet angle f1 for each of several facet angles f0 (27, 30, 33, 35, 38, 40 and 42 degrees), where the incident transmitted angle βᵢ is set to about −100 degrees and the refractive index of the transflector body n is set to about 1.6;

FIG. 8 shows schematically light directed onto the structured surface of an exemplary transflector from the (+) and from the (−) incidence directions;

FIG. 9 represents plots of facet angle pairs for the reflective and transmissive modes, where the refractive index of transflector body was set to about 1.6, the reflected incident angle αᵢ was set to about 30 degrees, the transmitted incident angle βᵢ was set to about + or −100 degrees, and where the exit angles βₑ and αₑ were set to about 0, −10 and −20 degrees;

FIG. 10 represents plots of facet angle pairs for the reflective and transmissive modes, where the refractive index of transflector body was set to about 1.6, the reflected incident angle αᵢ was set to about 30 degrees, the transmitted incident angle βᵢ was set to about + or −110 degrees, and where the exit angles βₑ and αₑ were set to about 0, −10 and −20 degrees;

FIG. 11 represents plots of facet angle pairs for the reflective and transmissive modes, where the refractive index of transflector body was set to about 1.6, the reflected incident angle αᵢ was set to about 30 degrees, the transmitted incident angle βᵢ was set to about + or −120 degrees, and where the exit angles βₑ and αₑ were set to about 0, −10 and −20 degrees;

FIG. 12 represents plots of facet angle pairs for the reflective and transmissive modes, where the refractive index of transflector body was set to about 1.55, the reflected incident angle αᵢ was set to about 30 degrees, the transmitted incident angle βᵢ was set to about + or −100 degrees, and where the exit angles βₑ and αₑ were set to about 0, −10 and −20 degrees;

FIG. 13 represents plots of facet angle pairs for the reflective and transmissive modes, where the refractive index of transflector body was set to about 1.55, the reflected incident angle αᵢ was set to about 30 degrees, the transmitted incident angle βᵢ was set to about + or −110 degrees, and where the exit angles βₑ and αₑ were set to about 0, −10 and −20 degrees;

FIG. 14 represents plots of facet angle pairs for the reflective and transmissive modes, where the refractive index of transflector body was set to about 1.55, the reflected incident angle αᵢ was set to about 30 degrees, the transmitted incident angle βᵢ was set to about + or −120 degrees, and where the exit angles βₑ and αₑ were set to about 0, −10 and −20 degrees;

FIG. 15 represents plots of facet angle pairs for the reflective and transmissive modes, where the refractive index of transflector body was set to about 1.5, the reflected incident angle αᵢ was set to about 30 degrees, the transmitted incident angle βᵢ was set to about + or −100 degrees, and where the exit angles βₑ and αᵢ were set to about 0, −10 and −20 degrees;

FIG. 16 represents plots of facet angle pairs for the reflective and transmissive modes, where the refractive index of transflector body was set to about 1.5, the reflected incident angle αᵢ was set to about 30 degrees, the transmitted incident angle βᵢ was set to about + or −110 degrees, and where the exit angles βₑ and αₑ were set to about 0, −10 and −20 degrees;

FIG. 17 represents plots of facet angle pairs for the reflective and transmissive modes, where the refractive index of transflector body was set to about 1.5, the reflected incident angle αᵢ was set to about 30 degrees, the transmitted incident angle βᵢ was set to about + or −120 degrees, and where the exit angles βₑ and αₑ were set to about 0, −10 and −20 degrees;

FIG. 18 represents plots of facet angles against the transflector body refractive index n for βᵢ set to about −100 degrees, αᵢ set to about 30 degrees, and βₑ about the same as αₑ and plotted for 0, −10, −20 degrees;

FIG. 19 represents plots of facet angles against the transflector body refractive index n for βᵢ set to about −110 degrees, αᵢ set to about 30 degrees, and βₑ about the same as βₑ and plotted for 0, −10, −20 degrees; and

FIG. 20 represents plots of facet angles against the transflector body refractive index n for βᵢ set to about −120 degrees, αᵢ set to about 30 degrees, and βₑ about the same as αₑ and plotted for 0, −10, −20 degrees.

### DETAILED DESCRIPTION

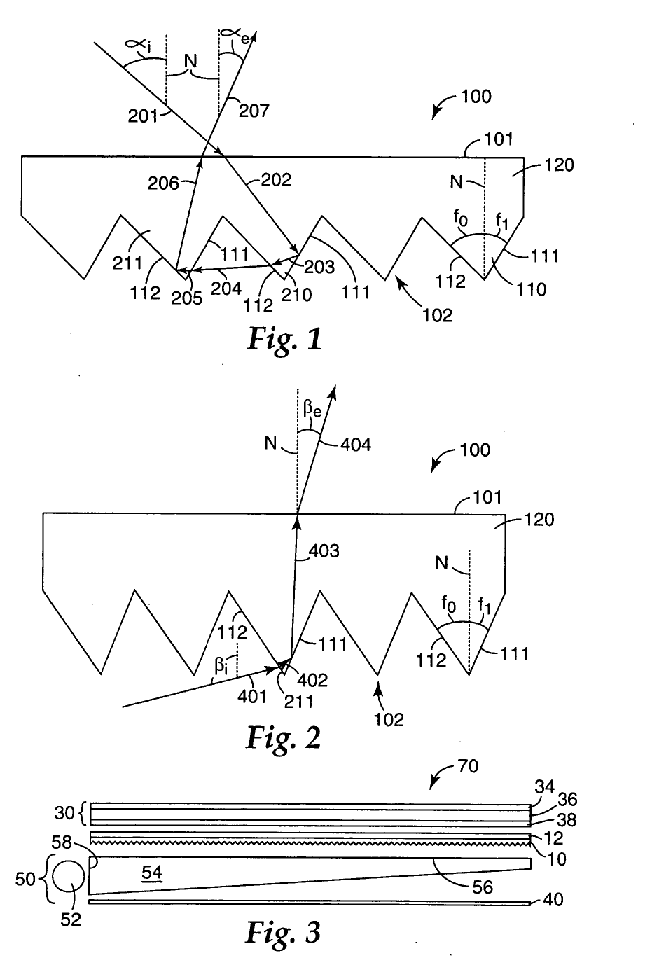

Referring now to the drawings, wherein like reference numbers designate similar elements, FIGS. 1 and 2 show a partial cross-sectional view of a transflector 100 constructed according to an exemplary embodiment of the present disclosure. The transflector 100 includes a body 120 having a surface 101, which is preferably a substantially planar surface, and a structured surface 102. In the context of the present disclosure, the term “transflector” is used to refer to an optical component that reflects light incident on one of its surfaces, for example, the surface 101 shown in FIG. 1, with a maximum intensity at a particular reflected exit angle, and, at the same time, the optical component transmits rays incident on another surface, for example, the structured surface 102 shown in FIG. 2, with a maximum intensity at a particular transmitted exit angle.

In some exemplary embodiments, the surface 101 may be structured or textured. For example, the surface 101 may be a matte surface. The structured surface 102 includes light-directing protrusions, such as prismatic structures 110. Preferably, the prismatic structures 110 include similarly shaped prisms, which in some exemplary embodiments of the present disclosure have apexes that are substantially symmetrical about a horizontal axis. Optionally, the structured surface 102 may include structures additional to the prismatic structures 110. Such additional structures may be suitably interspersed with the prismatic structures 110, and may include prismatic structures having other apex angles or heights, grooves, discrete bumps or depressions, diffusion-inducing structures, and others.

Some exemplary embodiments of the transflectors constructed according to the present disclosure may include structured surfaces, in which neighboring prismatic structures are tilted with respect to each other, prismatic structures including prisms that have different apex angles, prismatic structures having rounded or curved facets, or prismatic structures including a pattern of structural variations, such as prismatic structures having amplitude or angle that varies along an individual prismatic structure. Such exemplary structures are described, for example, in U.S. Pat. No. 6,354,709 to Campbell et al., entitled “Optical Film,” and in a commonly assigned Gardiner et al. U.S. application Ser. No. 09/415,471, entitled “Optical Element Having Programmed Optical Structures,” U.S. Pat. No. 5,917,664 to O'Neill et al., entitled “Brightness Enhancement Film With Soft Cutoff,” U.S. Pat. No. 5,771,328 to Wortman et al., entitled “Light Directing Film Having Variable Height Structured Surface and Light Directing Article Constructed Therefrom,” and U.S. Pat. No. 6,280,063 to Fong et al., entitled “Brightness Enhancement Article,” the disclosures of which are hereby incorporated by reference herein to the extent they are not inconsistent with the present disclosure.

The prismatic structures 110 each have two sets of facets, first facets 111 and second facets 112. Facets 111 and 112 are disposed at angles f0 and f1, respectively, with respect to a normal, depicted by imaginary lines N, to the surface 101. Transflectors constructed according to the present disclosure can be made, for example, from cast and cure materials, such as cast and cure epoxy acrylates, thermoplastics for compression molding, such as polymethylmethacrylate (PMMA), polycarbonate, or any other suitable transmissive material or materials. The pitch, or the distance between apexes, of the prismatic structures 110 is typically from about 5 to about 500 microns, but other dimensions are within the scope of the present disclosure, depending on the specific application and other factors.

In some exemplary embodiments, the pitch can be chosen to reduce Moiré effects, which may otherwise occur if the transflector pitch is sufficiently close to a periodic structure of another display component, such as Vikuiti™ Brightness Enhancement Film (BEF), available from 3M Company, or a pixel array. Typical exemplary transflector body thicknesses range from about 25 microns to about 300 microns, but other thicknesses may be used when appropriate. Other exemplary dimensions of transflectors constructed according to the present disclosure may include prismatic structures with the height of about 41 microns for the pitch of about 47 microns and the angle between prism facets of about 60 degrees. In typical embodiments of the present disclosure, the smaller angle between the facets of prismatic structures 110 will be less than about 70 degrees.

FIG. 1 illustrates operation of the transflector 100 in a reflective mode. Typically, such reflective mode is facilitated by the optical interactions between neighboring light-directing protrusions, for example, prismatic structures 211 and 210 shown in FIG. 1. Specifically, in reflective mode, a light ray 201, which may originate from an ambient light source, falls onto the surface 101 at a reflected incident angle αᵢ with respect to a normal N, and is then refracted into the body 120 of the transflector 100. The refracted light ray 202 then is reflected by total internal reflection (TIR) at the facet 111 of a first prismatic structure 210. As a result, the ray 202 is redirected to the facet 112 of the prismatic structure 210, as illustrated by a light ray 203.

Referring further to FIG. 1, the light ray 203 is refracted at the facet 112 of the first prismatic structure 210, as illustrated by a light ray 204, which propagates through air until it reaches a second prismatic structure 211. The light ray 204 is then refracted through the facet 111 of the second prismatic structure 211, as shown by a light ray 205. The light ray 205, in turn, is reflected by TIR from the facet 112 of the second prismatic structure 211. Upon reflection, the ray 205 changes direction, as shown by a light ray 206. The light ray 206 propagates through the body 120 of the transflector 100 and refracts at the surface 101, as shown by a light ray 207. The light ray 207 emerges from the body 120 of the transflector 100 at a reflected exit angle αₑ with respect to a normal N.

FIG. 2 illustrates operation of the prismatic transflector 100 in a transmissive mode. In the transmissive mode, a light ray 401, which may originate from a backlight, such as a backlight described in more detail with reference to FIG. 3, is incident on the structured surface 102 of the transflector 100 at a transmitted incident angle βᵢ with respect to a normal N. The light ray 401 is incident onto the face 112 of a prismatic structure 211 and is refracted into the body 120 of the transflector 100 at the facet 112, as shown by a light ray 402. The refracted light ray 402 passes through the prismatic structure 211 and is reflected by TIR from the facet 111, changing direction as shown by a light ray 403. The light ray 403 subsequently propagates through the body 120 of the transflector 100 and refracts at the surface 101, as shown by a light ray 404. The light ray 404 emerges from the body 120 of the transflector 100 at a transmitted exit angle βₑ with respect to a normal N.

An exemplary transflector constructed according to the present disclosure can be configured so that it satisfies particular reflective mode requirements, such as maximum reflected intensity at a certain angle, while retaining desired transmissive properties, including redirecting incident light in a manner similar to a turning film. Further, an exemplary transflector constructed according to the present disclosure can be configured so that a maximum output intensity of light in a transmission mode is provided in substantially the same direction as a maximum output intensity of light in a reflection mode. In accordance with the principles of the present disclosure, these and related goals may be accomplished by calculating the ray directions for each refraction and each reflection along the representative ray paths for both the reflective (FIG. 1, rays 201-207) and transmissive (FIG. 2, rays 401-404) modes described above.

Those of ordinary skill in the art will readily recognize that refractions at the interfaces of exemplary transflectors, for example, at the surface 101 and facets 111 and 112, will be governed by Snell's law. In particular, Snell's law will define the relationships between the directions of the rays 201 and 202, 203 and 204, 204 and 205, 206 and 207, shown in FIG. 1, and between the directions of the rays 401 and 402, 403 and 404, shown in FIG. 2. Those of ordinary skill in the art will also readily appreciate that for each instance of TIR, for example at the facets 111 and 112, incident and reflected angles will be equal. In accordance with these principles, exit angles in both the reflected and the transmitted modes of operation (i.e., αₑ and βₑ in the configuration shown in FIGS. 1 and 2) may be found based on the following parameters: facet angles f0 and f1, incident angle αᵢ or βᵢ, and the refractive index n of the transflector body 120.

These parameters and their relationships can be entered into a spreadsheet, such as Microsoft® Excel spreadsheet, or another suitable application or program, and their values can be appropriately optimized based on the initial system parameters, characteristics of the input illumination, and the desired characteristics of the output illumination. In addition, those of ordinary skill in the art will readily appreciate that during such optimizations TIR condition should be satisfied at the prism facets, which may be ascertained by comparing the angle of incidence of each representative light ray with the known critical angle for a particular material of the exemplary transflector. In addition, ray 205 should intersect the facet 112.

FIG. 3 is a schematic cross-sectional view of a display module 70, which includes an image-forming device 30 (such as an LCD), an exemplary transflector 10 constructed according to the present disclosure, and a backlight 50. The display module 70 may include other optical components in addition to or in place of the components shown, as would be known to those of ordinary skill in the art, if such additional or alternative components are needed or desired for a particular application. The backlight 50 includes a light source 52 (for example, a linear light source such as a fluorescent tube, a plurality of light emitting diodes (“LEDs”) or another suitable source or sources of light), a lightguide 54 (for example, a dielectric lightguide), and a back reflector 40. The lightguide 54 has a light input side 58, which is optically connected to the light source 52 and may be disposed adjacent to the light source 52. The lightguide 54 also has a light output side 56 that faces the image-forming device 30. The image-forming device 30 may include a first polarizer 34, a second polarizer 38, and a layer of liquid crystal material 36 disposed between the first polarizer 34 and the second polarizer 38.

The backlight 50 may include other components in addition to or in place of the components shown, as would be known to those of ordinary skill in the art. For example, the backlight 50 may further include reflector or reflectors surrounding the light source or sources. In some embodiments, light sources may be disposed at two or more edges of the lightguide 54, and the lightguide may have a variety of suitable configurations. Other configurations of the backlight may be used with the appropriate embodiments of the present disclosure, such as direct-lit backlights, hollow lightguide backlights and others. The image-forming device 30 may include other components in addition to or in place of the components shown, as would be known to those of ordinary skill in the art.

The transflector 10 can be disposed between the lightguide 54 and the display device 30. In the exemplary embodiment shown, the lightguide 54 is wedge-shaped, with the thickness of the lightguide tapering in the direction away from the light source 52. In such exemplary display modules 70, at least a portion of light originating from the light source 52 will enter the lightguide 54 through the light input side 58, propagate within the lightguide 54 by TIR from its sides, and exit the lightguide 54 through the output side 56. In a dielectric wedge-shaped lightguide, extraction of light from its interior will take place primarily due to TIR failure at the light guide's interfaces with air. Additional structures may be added to facilitate extraction of light from the lightguide 54.

As the rays propagate in the direction of decreasing thickness of the wedge, the ray angles decrease by one half of the wedge angle at each reflection from the slanted side. Once the ray angles decrease to just below the critical angle, they escape the lightguide 54 through the output side 56 at glancing angles to the output side 56. For typical wedge-shaped lightguides, the range of escape angles is from about 90 degrees (glancing) to about 50 degrees with respect to a normal to the output side, depending on the wedge angle and the refractive index of the wedge lightguide. A steeper wedge with a high refractive index would result in lower escape angles. In-molded surface roughness or other structures introduced into the lightguide may also cause the rays to escape at lower angles, such as about 30 degrees. Those of ordinary skill in the art will readily appreciate that a variety of other mechanisms can be used to extract light from the lightguide 54.

Referring further to FIG. 3, the transflector 10 in the display module 70 may be a freestanding structure, or it can be attached to a substrate 12, for example, by lamination, casting, co-extrusion, molding the appropriately shaped surface structures into the substrate 12, or by any other suitable bonding technique. For example, the transflector 10 can be attached to the substrate 12 using an adhesive, such as a diffuse adhesive. The substrate 12 may be or may include any transmissive optical component, such as a diffuser, for example, a volume diffuser, enhancement films such as reflective polarizers, for example, Vikuiti™ Dual Brightness Enhancement Film (DBEF), Vikuiti™ Diffuse Reflective Polarizer Film (DRPF), both available from 3M Company, or a liquid crystal reflective polarizer, an absorbing polarizer, a support structure, or any other suitable component.

Since illumination with collimated light results in optimum brightness of an image viewed in reflection at a certain angle, the external illumination source preferably is substantially collimated, which is often the case with sunlight or typical office lighting. However, illumination with uncollimated light is also within the scope of the present disclosure. For example, a small amount of diffusion is often beneficial where some spread of the viewing angle is desired, and where it is desirable to break up the image of the source. The amount of diffusion, however, should be carefully balanced against the loss of brightness, which is particularly significant in LCDs due to their low transmission. Diffusion may be introduced, for example, by adding curvature into the facets on the structured surface of exemplary transflectors of the present disclosure. Other options include using volume-diffusing materials in the transflector body itself or in an adhesive used to secure an exemplary transflector to another structure. Other techniques include roughening one or more surfaces of the transflector, for example, by creating grooves, ridges or other patterns of surface roughness, or creating a pattern of structural variations, substantially random or cyclical, on the structured surface.

Exemplary transflectors constructed according to the present disclosure may be incorporated into a variety of handheld display devices. In common display devices, the incident angle of ambient light illumination is typically about 30 degrees with respect to a normal axis of the display device, sometimes with a variation of about +10 to about −10 degrees. For the illumination incident at about 30 degrees, the direction of specular reflection would be at about −30 degrees, which is where glare usually occurs. The preferred viewing angle for handhelds is commonly at about −10 degrees, or about 40 degrees from the incident direction and about 20 degrees away from the usual glare direction. Other preferred viewing angles are also within the scope of the present disclosure, for example, a display module for a notebook or a desktop computer is typically viewed at about 0 degrees with respect to an axis normal to the display device.

In display modules such as the display module 70 shown in FIG. 3, typical wedge lightguides are configured so that the peak angle of the light emerging from the exit surface is at about 80 degrees or less with respect to the exit surface, which corresponds to the transmitted incidence angles of about 100 degrees or more with respect to a normal N. Other common transmitted incident angles range from about 90 degrees to about 140 degrees with respect to a normal N, but other values are also within the scope of the present disclosure, depending on the specific application and other factors. Where ambient light is insufficiently bright to be used on its own, it is usually desirable to utilize exemplary embodiments of the present disclosure, in which the transmitted and reflected exit angles are about the same for the maximum intensity of output light. In other exemplary embodiments, the transmitted and reflected exit angles for the maximum intensity of output light may have values that are different from each other.

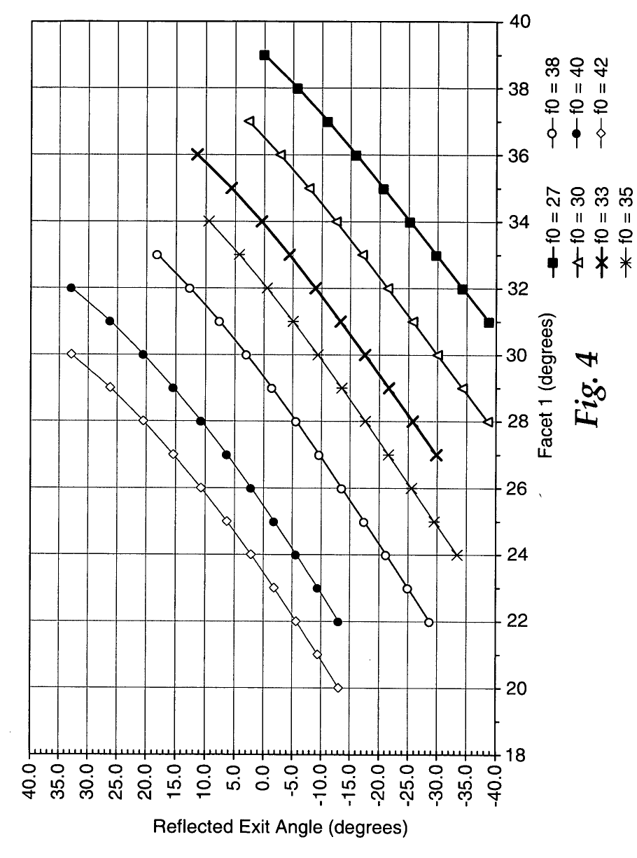

FIG. 4 represents the calculated values of reflected exit angle αₑ plotted against the facet angle f1 for each of several facet angles f0 (27, 30, 33, 35, 38, 40 and 42 degrees), where the incident reflected angle αᵢ is set to about 30 degrees and the refractive index of the transflector body n is set to about 1.6. From the plot of FIG. 4, one can see that a locus of points (f0, f1) passes through the exit angle of about −10 degrees. Two additional caveats are imposed on the light rays traversing an exemplary transflector of the present disclosure in reflection mode. The first caveat is that the sets of parameters are such that the TIR condition for rays 202, 203 and rays 205, 206 (402, 403 in transmission) is satisfied. The second caveat is that the sets of parameters are such that the ray 204 in FIG. 1 intersects the facet of a neighboring prismatic structure (for example, facet 111 of prismatic structure 211), and ray 205 intersects the other facet of that prismatic structure (for example, facet 112 of prismatic structure 211).

The TIR condition can be checked, for example, by comparing the ray angle to the critical angle for the material of the transflector body. Table I shows calculated exemplary boundary values for the angle f1 of the facets 111 for several exemplary refractive indices n and reflected incident angles αᵢ. For these refractive indices and reflected incident angles, rays 202 and 203 shown in FIG. 1 (or rays 402 and 403 in transmission, if light is incident from the left) satisfy the TIR condition at the facet 111, if the facet angle f1 is less than or equal to about the appropriate value in Table I:

TABLE I

| Transflector Body | f1 for | f1 for | f1 for |
|---|---|---|---|
| Refractive Index n | αᵢ = 30 degrees | αᵢ = 20 degrees | αᵢ = 10 degrees |
| 1.5 | 28 | 36 | 41 |
| 1.55 | 31 | 37 | 43 |
| 1.6 | 33 | 39 | 45 |
| 1.65 | 35 | 40 | 46 |
| 1.7 | 36 | 42 | 48 |

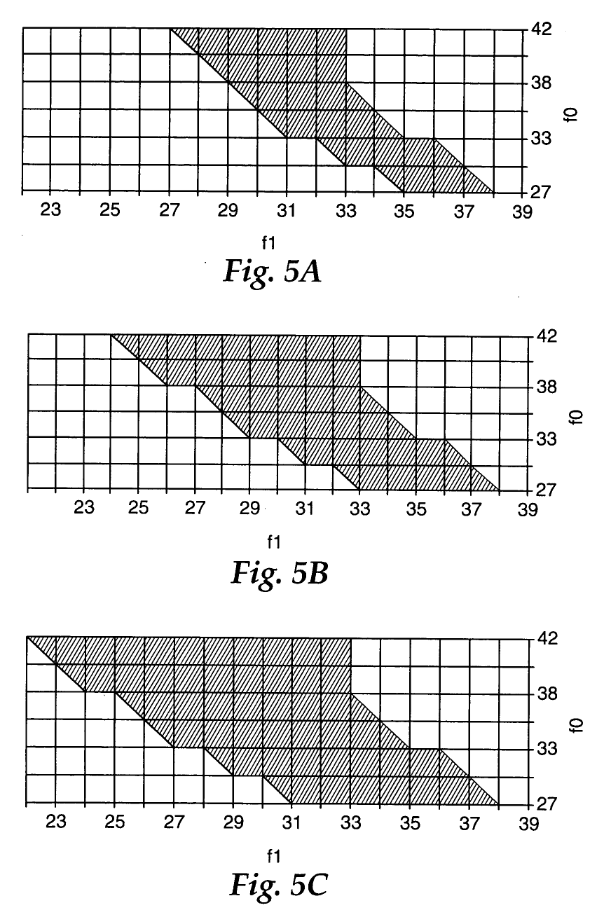

FIGS. 5A-5D illustrate the calculated TIR condition for the reflected incident angle αᵢ of about 30 degrees and for several different values of the transflector body refractive index n (n set to about 1.4 in FIG. 5A, n set to about 1.5 in FIG. 5B, n set to about 1.6 in FIG. 5C, and n set to about 1.7 in FIG. 5D). For these refractive indices and reflected incident angles, rays 205 and 206 shown in FIG. 1 satisfy the TIR condition at the facet 112 for the facet angle pairs (f0; f1) that are represented by the shaded areas in FIGS. 5A-5D.

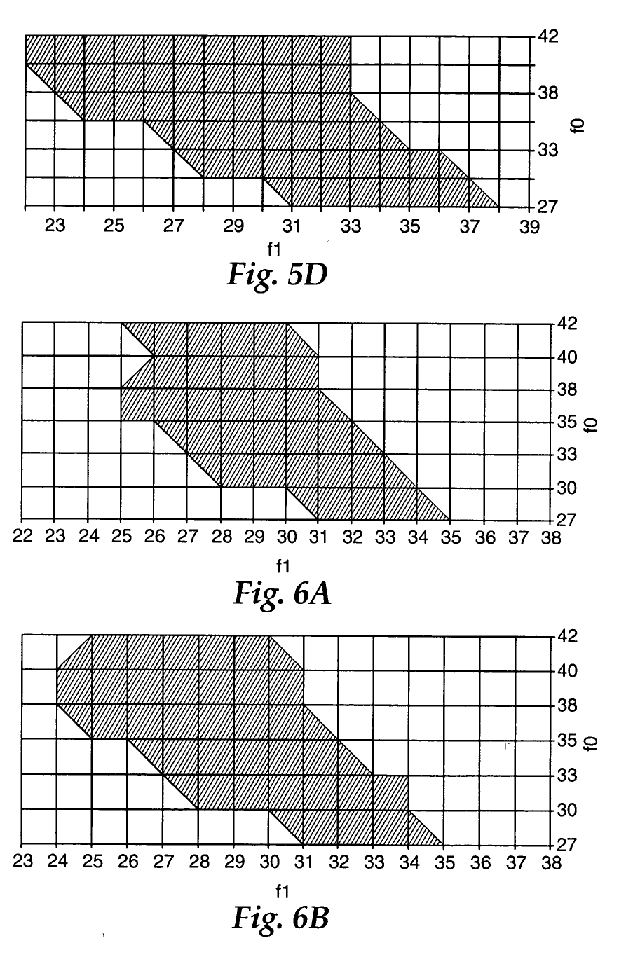

A ray trace computer code, such as any suitable commercially available ray trace software, can be used to determine whether the second caveat is satisfied. In FIGS. 6A and 6B, the shaded areas represent pairs of facet angles (f0, f1), found by ray tracing, that satisfy the condition that for about 40% or more of the surface area on which ray 205 may be incident, ray 205 intersects the facet 112. FIG. 6A represents the data for transmitted incident angle of about 30 degrees and the transflector body refractive index of about 1.5, while FIG. 6B represents the data for reflected incident angle of about 30 degrees and the transflector body refractive index of about 1.6. The facet pairs (f0, f1) represented by the shaded areas also satisfy the condition that the intensity in the principal reflection direction is greater than about 40% of incident intensity.

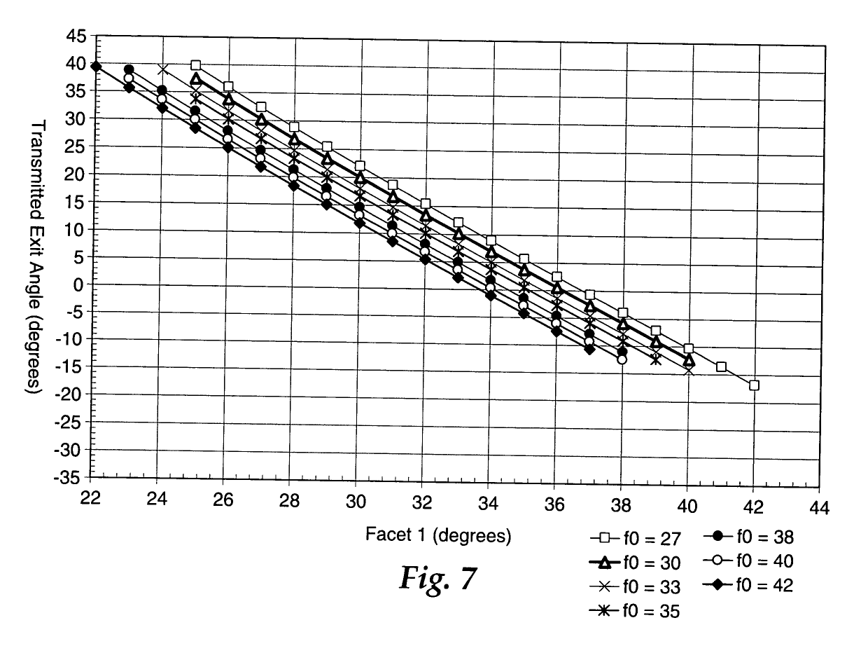

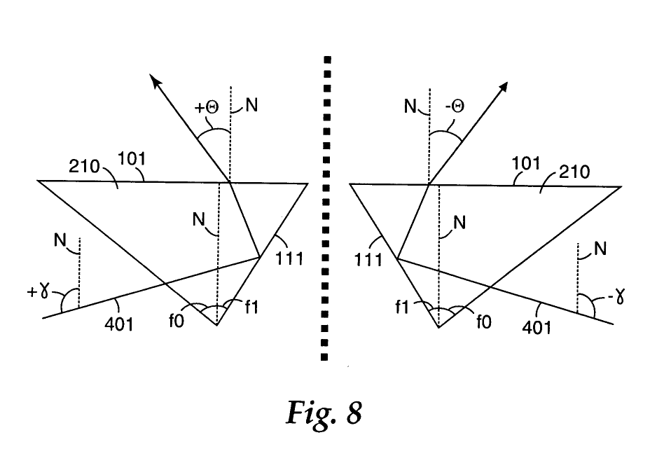

FIG. 7 represents the calculated transmitted exit angle βₑ plotted against the facet angle f1 for each of several facet angles f0 (27, 30, 33, 35, 38, 40 and 42 degrees), where the incident transmitted angle βᵢ is set to about −100 degrees and the refractive index n is set to about 1.6. From the plot of FIG. 7, one can see that a locus of points (f0, f1) passes through the transmitted exit angle of about +10 degrees. Here, +10 degrees or −10 degrees may be selected, because transmission mode allows the flexibility to direct light onto the structured surface from either the (+) or the (−) incidence direction, for example, by changing the location of the light source and/or configuration of the lightguide. This concept is illustrated in FIG. 8, which shows schematically a prismatic structure 210 having facet angles f0 and f1 and a light ray 401 incident onto the prismatic structure 210 from either the (−) or the (+) direction. The ray 401 incident onto the prismatic structure 210 from the (+) direction makes a positive angle +γ with respect to a normal N to the surface 101. After undergoing TIR at the facet 111, the ray exits the transflector body at a positive angle +θ with respect to a normal N. If, however, the ray 401 is incident onto the prismatic structure from the (−) direction, it makes a negative angle −γ with respect to a normal N, undergoes TIR at the facet 111, and exits the transflector body at a negative angle −θ. To maintain consistency with the reflected light case, labels of the facets can be interchanged, as shown in FIG. 8.

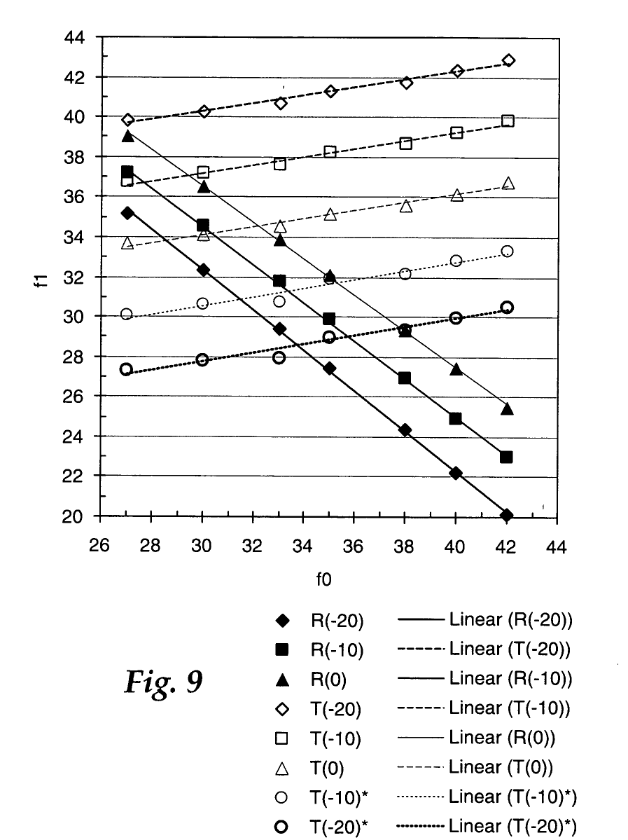

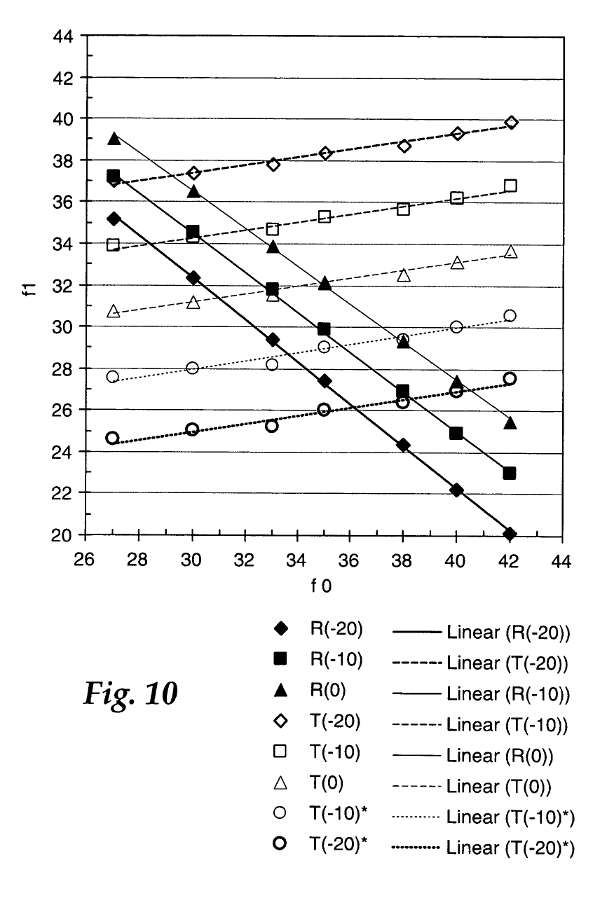

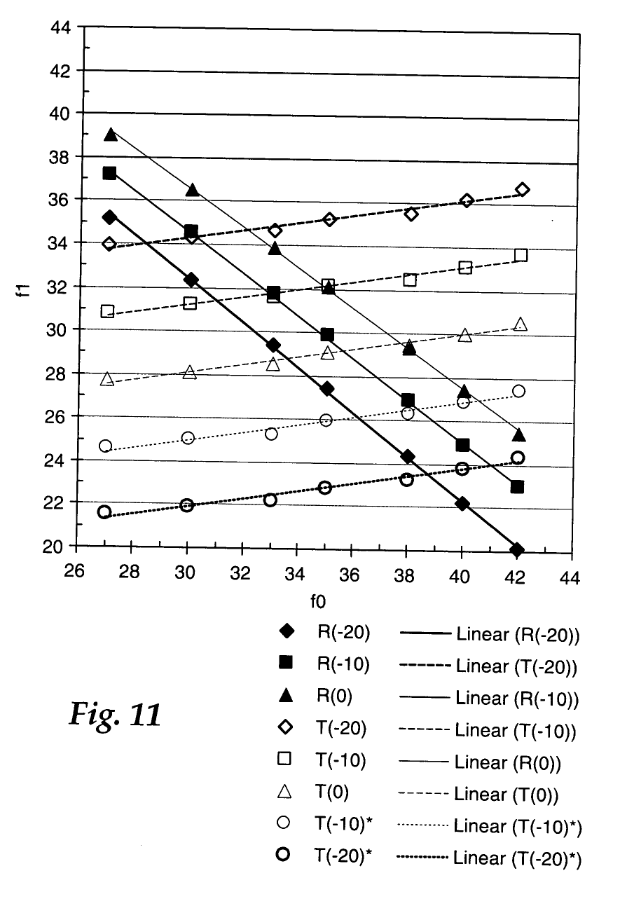

Those of ordinary skill in the art will readily recognize that the calculations explained above may be easily repeated for any set of parameters, such as a variety of incident angles βᵢ and αᵢ, polymer refractive index n, and exit angles βₑ and αₑ. For example, FIGS. 9-11 represent plots of calculated facet angle pairs (f0, f1) both for the reflective and for the transmissive modes, where the refractive index of transflector body was set to about 1.6 and the reflected incident angle αᵢ was set to about 30 degrees. Transmissive data plots are shown for positive as well as for negative values of the transmitted incident angle βᵢ, with the plots for negative values of βᵢ marked with a “*.” In FIG. 9, βᵢ was set to about + or −100 degrees, in FIG. 10, βᵢ was set to about + or −110 degrees, and in FIG. 11, βᵢ was set to about + or −120 degrees. Different curves in FIGS. 9-11 represent data obtained for the exit angles βₑ and αₑ of about 0, −10 and −20 degrees, as labeled on the graphs. As it is apparent from the figures, transmissive and reflective plots for which the exit angles βₑ and αₑ were set to about the same value have several intersection points. The intersection points correspond to the transflector parameters, such as the refractive index and the facet angles f0 and f1, for which the reflected exit angle is about the same as the transmitted exit angle.

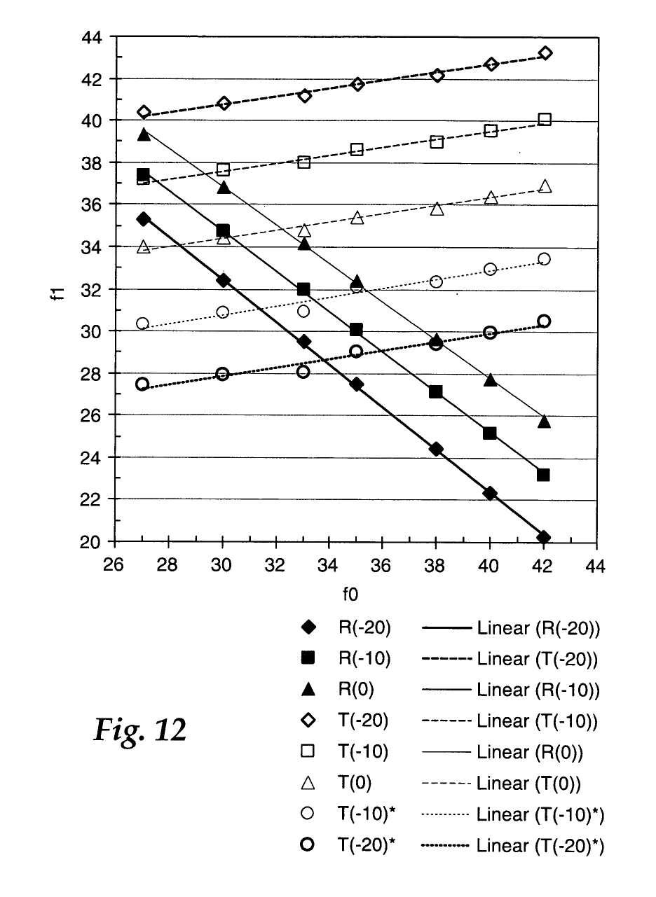

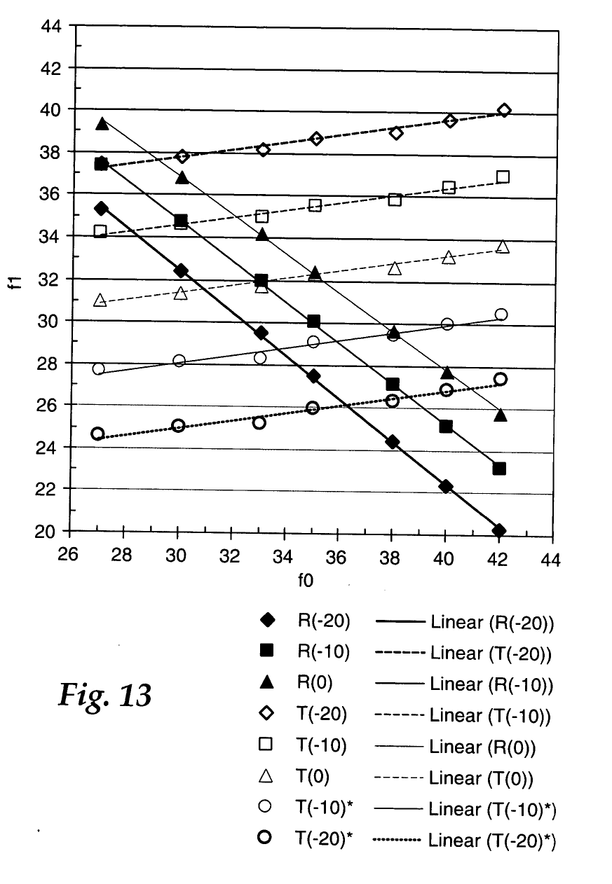

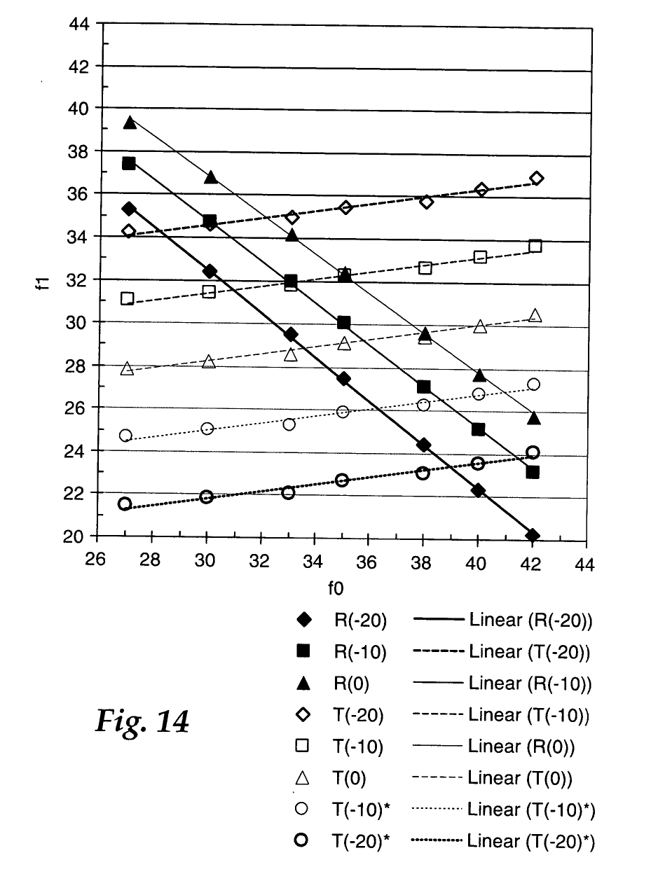

Similarly, FIGS. 12-14 represent plots of calculated facet angle pairs (f0, f1) both for the reflective and for the transmissive modes, where the refractive index of transflector body was set to about 1.55 and the reflected incident angle αᵢ was set to about 30 degrees. Transmissive data plots are shown for positive as well as for negative values of the transmitted incident angle βᵢ, with the plots for negative values of βᵢ marked with a “*.” In FIG. 12, βᵢ was set to about + or −100 degrees, in FIG. 13, βᵢ was set to about + or −110 degrees, and in FIG. 14, βᵢ was set to about + or −120 degrees. Different curves in FIGS. 12-14 represent data obtained for exit angles βₑ and αₑ of about 0, −10 and −20 degrees, as labeled on the graphs. As it is apparent from the figures, transmissive and reflective plots for which the exit angles βₑ and αₑ were set to about the same value have several intersection points. The intersection points correspond to the transflector parameters, such as the refractive index and the facet angles f0 and f1, for which the reflected exit angle is about the same as the transmitted exit angle.

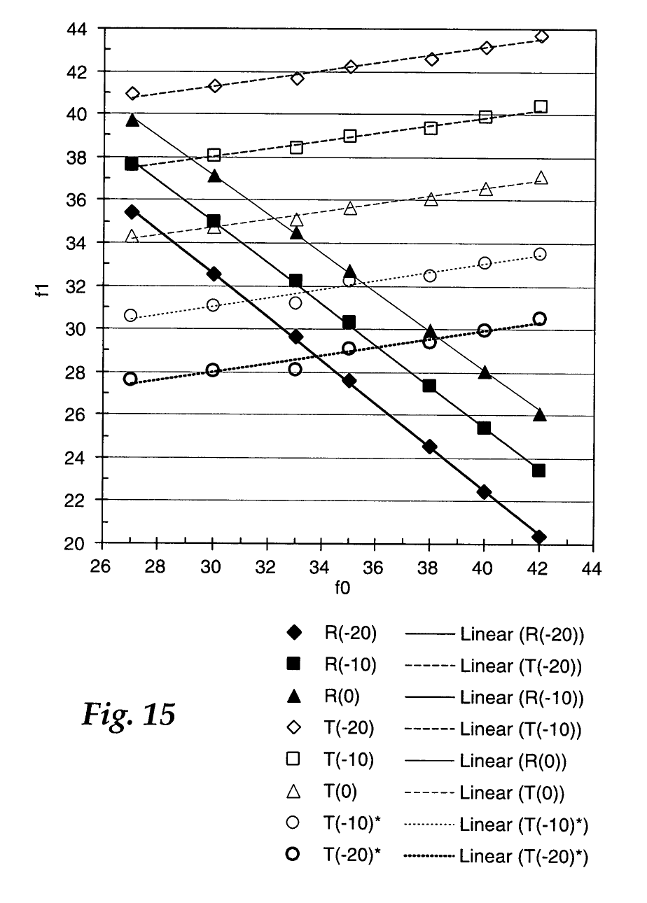

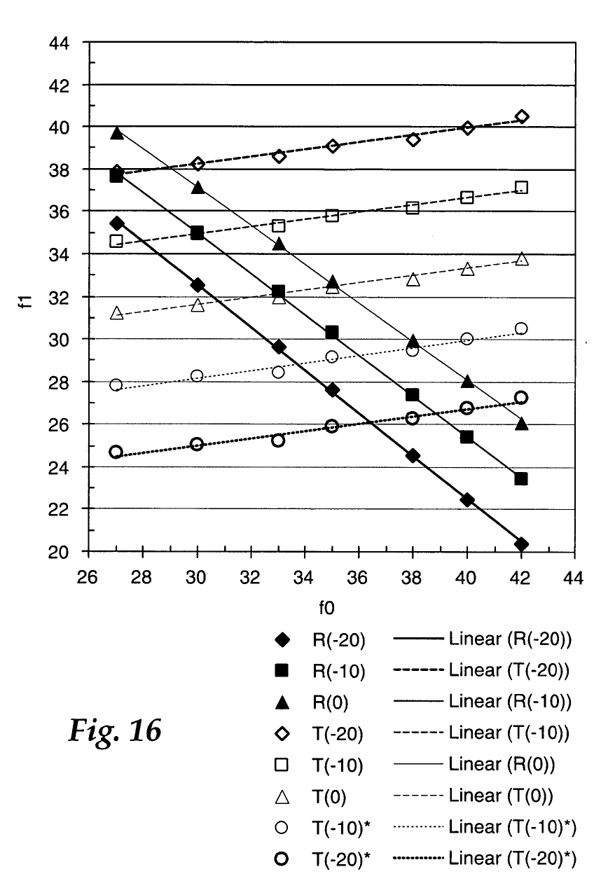

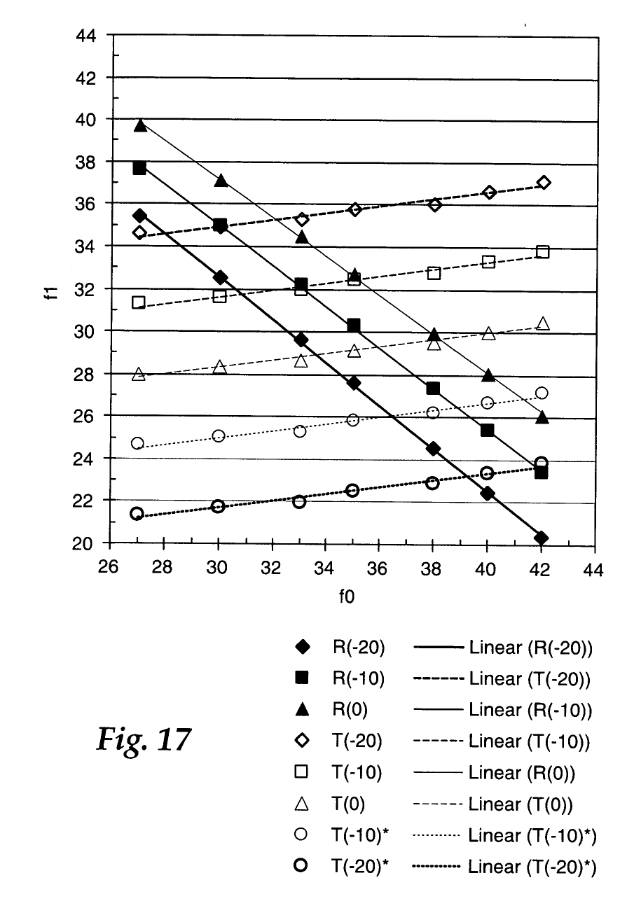

FIGS. 15-17 represent plots of calculated facet angle pairs (f0, f1) both for the reflective and for the transmissive modes, where the refractive index of transflector body was set to about 1.5 and the reflected incident angle αᵢ was set to about 30 degrees. Transmissive data plots are shown for positive as well as negative values of the transmitted incident angle βᵢ, with the plots for negative values of βᵢ marked with a “*.” In FIG. 15, βᵢ was set to about + or −100 degrees, in FIG. 16, βᵢ was set to about + or −110 degrees, and in FIG. 17, βᵢ was set to about + or −120 degrees. Different curves in FIGS. 15-17 represent data obtained for exit angles βₑ and αₑ of about 0, −10 and −20 degrees, as labeled on the graphs. As it is apparent from the figures, transmissive and reflective plots for which the exit angles βₑ and αₑ were set to about the same value have several intersection points. The intersection points correspond to the transflector parameters, such as the refractive index and the facet angles f0 and f1, for which the reflected exit angle is about the same as the transmitted exit angle.

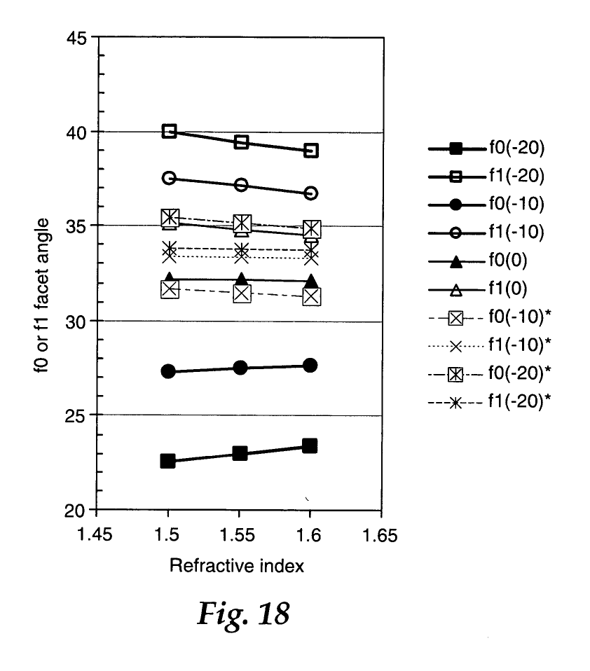

FIGS. 18-20 represent calculated facet angles f0 and f1 plotted on the same graphs against refractive indexes n of transflector bodies for several values of coincident exit angles βₑ and αₑ. Data plots are shown for positive as well as negative values of the transmitted incident angle βᵢ, with the data plots for negative values of βᵢ marked with a “*.” In FIG. 18, αᵢ was set to about 30 degrees, βᵢ was set to about − or +100, and βₑ and αₑ were set to about 0, −10 and −20 degrees, as labeled on the graphs. The values corresponding to the data points plotted in FIG. 18 are set forth in Table II:

TABLE II

| n = | 1.5 | 1.55 | 1.6 |
|---|---|---|---|
| f0(−20) | 22.6 | 23.0 | 23.4 |
| f1(−20) | 40.0 | 39.4 | 39.0 |
| f0(−10) | 27.3 | 27.5 | 27.7 |
| f1(−10) | 37.5 | 37.1 | 36.7 |
| f0(0) | 32.2 | 32.2 | 32.1 |
| f1(0) | 35.1 | 34.8 | 34.6 |
| f0(−10)* | 31.7 | 31.5 | 31.3 |
| f1(−10)* | 33.4 | 33.4 | 33.4 |
| f0(−20)* | 35.4 | 35.1 | 34.9 |
| f1(−20)* | 33.8 | 33.8 | 33.7 |

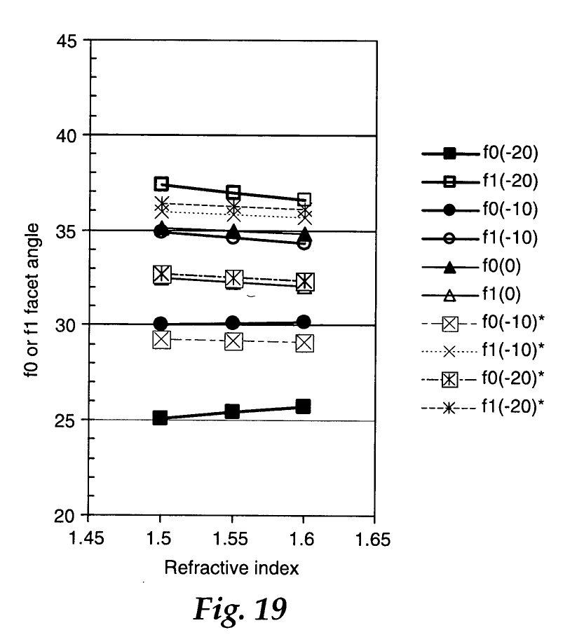

In FIG. 19, αᵢ was set to about 30 degrees, βᵢ was set to about − or +110, and βₑ and αₑ were set to about 0, −10 and −20 degrees, as labeled on the graphs. The values corresponding to the data points plotted in FIG. 19 are set forth in Table III:

TABLE III

| n = | 1.5 | 1.55 | 1.6 |
|---|---|---|---|
| f0(−20) | 25.1 | 25.4 | 25.7 |
| f1(−20) | 37.4 | 37.0 | 36.6 |
| f0(−10) | 30.0 | 30.1 | 30.2 |
| f1(−10) | 34.9 | 34.6 | 34.3 |
| f0(0) | 35.1 | 35.0 | 34.8 |
| f1(0) | 32.5 | 32.3 | 32.1 |
| f0(−10)* | 29.2 | 29.2 | 29.1 |
| f1(−10)* | 36.0 | 35.8 | 35.7 |
| f0(−20)* | 32.7 | 32.5 | 32.4 |
| f1(−20)* | 36.4 | 36.2 | 36.1 |

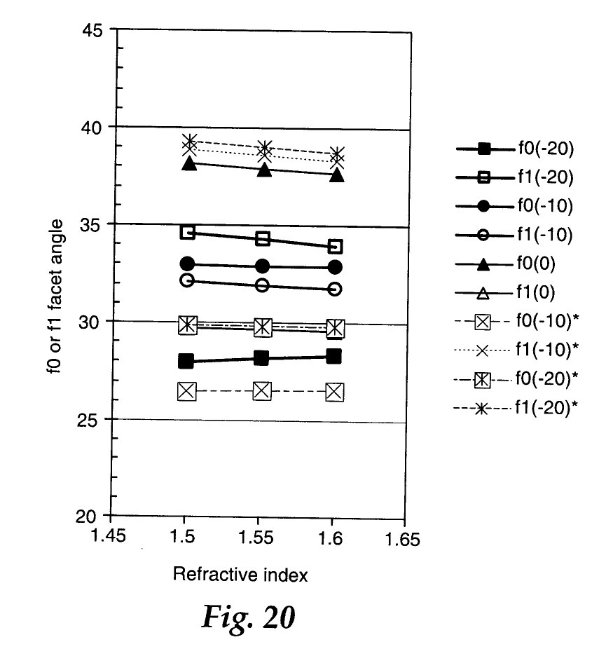

In FIG. 20, αᵢ was set to about 30 degrees, βᵢ was set to about − or +120, and βₑ and αₑ were set to about 0, −10 and −20 degrees, as labeled on the graphs. The values corresponding to the data points plotted in FIG. 20 are set forth in Table IV:

TABLE IV

| n = | 1.5 | 1.55 | 1.6 |
|---|---|---|---|
| f0(−20) | 27.9 | 28.1 | 28.3 |
| f1(−20) | 34.6 | 34.3 | 34.0 |
| f0(−10) | 33.0 | 32.9 | 32.9 |
| f1(−10) | 32.1 | 31.9 | 31.8 |
| f0(0) | 38.2 | 37.9 | 37.7 |
| f1(0) | 29.7 | 29.6 | 29.6 |
| f0(−10)* | 26.5 | 26.5 | 26.6 |
| f1(−10)* | 38.9 | 38.6 | 38.3 |
| f0(−20)* | 29.9 | 29.8 | 29.8 |
| f1(−20)* | 39.3 | 39.0 | 38.7 |

Thus, transflectors constructed according to exemplary embodiments of the present disclosure have a reflective mode, such that light rays incident onto one of the transflector's surfaces can be reflected at an angle different from the specular reflection angle. In addition, exemplary transflectors of the present disclosure have a transmissive mode, in which they operate by redirecting rays incident onto its structured surface at high incidence angles to smaller transmission angles. Further, according to the present disclosure, exemplary embodiments of the present disclosure can be configured to reflect light incident at a certain angle from an ambient source and redirect it in a particular direction toward a viewer. That particular direction may be about the same for both transmission and reflection modes. The appropriate design of the facet angles of exemplary embodiments of the present disclosure would permit one to use them in reflective mode, while retaining the transmissive properties of a turning film, or to use the two modes in cooperation.

The present disclosure provides a high efficiency transflector that is reflective to ambient light rays incident on its top surface within a range of incident ray angles, while it is also transmissive to rays incident on the structured surface within a different range of ray angles, thus capable of reducing overall power consumption in a display device. Typical exemplary transflectors constructed according to the present disclosure provide no image inversion. Further, the present disclosure may help reduce the cost of transflective LCDs by reducing the need for internal partial mirror structures that are presently often used for the reflective mode of transflective LCDs.

Although the transflectors and display modules constructed according to the present disclosure, as well as methods for making such transflectors, have been described with reference to specific exemplary embodiments, those of ordinary skill in the art will readily appreciate that changes and modifications may be made thereto without departing from the spirit and scope of the present disclosure.

1. A transflector comprising:
a transflector body having a first surface and a second surface, the second surface being a structured surface comprising a plurality of prismatic structures having a first facet and a second facet, the first facet making an angle with respect to the second facet that is no more than about 70 degrees;
wherein, in a reflective mode, light incident onto the first surface at a reflected incident angle is refracted through the first surface, reflected at the first facet of a first prismatic structure, reflected at the second facet of a second prismatic structure, and refracted through the first surface with a maximum intensity at about a reflected exit angle, and
in a transmissive mode, light incident onto the second surface at a transmitted incident angle is directed by a prismatic structure to the first surface and refracted through the first surface with a maximum intensity at about a transmitted exit angle.

2. The transflector as recited in claim 1, wherein the reflected exit angle is about the same as the transmitted exit angle.

3. The transflector as recited in claim 1, wherein the first surface of the transflector body is substantially planar.

4. The transflector as recited in claim 1, wherein each first facet makes a first angle and each second facet makes a second angle with respect to a normal to the first surface and absolute values of the first and second angles are from about 22° to about 42°.

5. The transflector as recited in claim 1, wherein absolute values of the reflected and transmitted exit angles are from about 0 degrees to about 20 degrees with respect to an axis normal to the first surface.

6. The transflector as recited in claim 1, wherein absolute value of the transmitted incident angle is from about 100 to about 120 degrees with respect to an axis normal to the first surface.

7. The transflector as recited in claim 1, wherein absolute value of the reflected incident angle is from about 20 to about 40 degrees with respect to an axis normal to the first surface.

8. The transflector as recited in claim 1, wherein the second surface comprises prismatic structures having curved facets.

9. The transflector as recited in claim 1, wherein the transflector body comprises a volume diffuser.

10. The transflector as recited in claim 1, further comprising a layer of diffuse material disposed on the first surface.

11. The transflector as recited in claim 1, wherein at least one of the surfaces of the transflector body is roughened.

12. The transflector as recited in claim 1, wherein the second surface comprises a pattern of structural variations.

13. The transflector as recited in claim 1, wherein the second surface comprises prismatic structures of different average heights.

14. The transflector as recited in claim 1, further comprising a substrate attached to the first surface.

15. The transflector as recited in claim 14, wherein the substrate comprises at least one of: a reflective polarizer, an absorbing polarizer, and a diffuser.

16. A transflector comprising:
a transflector body having a first surface and a second surface, the second surface being a structured surface comprising a plurality of prismatic structures having a first facet and a second facet, each first facet making a first angle and each second facet making a second angle with respect to a normal to the first surface, and absolute values of the first angles being different from absolute values of the second angles;
wherein, in a reflective mode, light incident onto the first surface at a reflected incident angle is refracted through the first surface, reflected at the first facet of a first prismatic structure, reflected at the second facet of a second prismatic structure, and refracted through the first surface with a maximum intensity at about a reflected exit angle, and
in a transmissive mode, light incident onto the second surface at a transmitted incident angle is directed by a prismatic structure to the first surface and refracted through the first surface with a maximum intensity at about a transmitted exit angle.

17. The transflector as recited in claim 16, wherein the reflected exit angle is about the same as the transmitted exit angle.

18. The transflector as recited in claim 16, wherein the first surface of the transflector body is substantially planar.

19. The transflector as recited in claim 16, wherein absolute values of the first and second facet angles are from about 22° to about 42°.

20. The transflector as recited in claim 16, wherein absolute values of the reflected and transmitted exit angles are from about 0 degrees to about 20 degrees with respect to an axis normal to the first surface.

21. The transflector as recited in claim 16, wherein absolute value of the transmitted incident angle is from about 100 to about 120 degrees with respect to an axis normal to the first surface.

22. The transflector as recited in claim 16, wherein absolute value of the reflected incident angle is from about 20 to about 40 degrees with respect to an axis normal to the first surface.

23. The transflector as recited in claim 16, wherein the second surface comprises prismatic structures having curved facets.

24. The transflector as recited in claim 16, wherein the transflector body comprises a volume diffuser.

25. The transflector as recited in claim 16, further comprising a layer of diffuse material disposed on the first surface.

26. The transflector as recited in claim 16, wherein at least one of the surfaces of the transflector body is roughened.

27. The transflector as recited in claim 16, wherein the second surface comprises a pattern of structural variations.

28. The transflector as recited in claim 16, wherein the second surface comprises prismatic structures of different average heights.

29. The transflector as recited in claim 16, further comprising a substrate attached to the first surface.

30. The transflector as recited in claim 29, wherein the substrate comprises at least one of: a reflective polarizer, an absorbing polarizer, and a diffuser.

31. A transflector comprising:
a transflector body having a refractive index, a first surface and a second surface, the second surface being a structured surface comprising a plurality of prismatic structures having a first facet and a second facet, each first facet making a first angle and each second facet making a second angle with respect to a normal to the first surface;
wherein the refractive index, the first angles and the second angles of the transflector body are configured for transflective operation characterized by a transmitted exit angle and a reflected exit angle, so that
in a reflective mode, light incident onto the first surface at a reflected incident angle is refracted through the first surface, reflected at the first facet of a first prismatic structure, reflected at the second facet of a second prismatic structure, and refracted through the first surface with a maximum intensity at about the reflected exit angle, and
in a transmissive mode, light incident onto the second surface at a transmitted incident angle is directed by a prismatic structure to the first surface and refracted through the first surface with a maximum intensity at about the transmitted exit angle.

32. The transflector as recited in claim 31, wherein the reflected exit angle is about the same as the transmitted exit angle.

33. The transflector as recited in claim 31, wherein the first surface of the transflector body is substantially planar.

34. The transflector as recited in claim 31, wherein absolute values of the first and second facet angles are from about 22° to about 42°.

35. The transflector as recited in claim 31, wherein absolute values of the reflected and transmitted exit angles are from about 0 degrees to about 20 degrees with respect to an axis normal to the first surface.

36. The transflector as recited in claim 31, wherein absolute value of the transmitted incident angle is from about 100 to about 120 degrees with respect to an axis normal to the first surface.

37. The transflector as recited in claim 31, wherein absolute value of the reflected incident angle is from about 20 to about 40 degrees with respect to an axis normal to the first surface.

38. The transflector as recited in claim 31, wherein the second surface comprises prismatic structures having curved facets.

39. The transflector as recited in claim 31, wherein the transflector body comprises a volume diffuser.

40. The transflector as recited in claim 31, further comprising a layer of diffuse material disposed on the first surface.

41. The transflector as recited in claim 31, wherein at least one of the surfaces of the transflector body is roughened.

42. The transflector as recited in claim 31, wherein the second surface comprises a pattern of structural variations.

43. The transflector as recited in claim 31, wherein the second surface comprises prismatic structures of different average heights.

44. The transflector as recited in claim 31, further comprising a substrate attached to the first surface.

45. The transflector as recited in claim 44, wherein the substrate comprises at least one of: a reflective polarizer, an absorbing polarizer, and a diffuser.

46. A display module comprising:
a transmissive image-forming device,
a backlight, and
a transflector having a body, the body having a first surface and a second surface, the second surface being a structured surface that comprises a plurality of prismatic structures having a first facet and a second facet, the first facet making an angle with respect to the second facet that is no more than about 70 degrees, said transflector disposed between the image-forming device and the backlight so that the first surface faces the image-forming device and the second surface faces the backlight;
wherein, in a reflective mode, light transmitted through the image-forming device at and incident onto the first surface at a reflected incident angle is refracted through the first surface, reflected at the first facet of a first prismatic structure, reflected at the second facet of a second prismatic structure, refracted through the first surface, and transmitted through the image-forming device with a maximum intensity at about a reflected exit angle, and
in a transmissive mode, light originating from the backlight and incident onto the second surface at a transmitted incident angle is directed by a prismatic structure to the first surface, refracted through the first surface, and transmitted through the image-forming device with a maximum intensity at about a transmitted angle.

47. The display module as recited in claim 46, wherein the reflected exit angle is about the same as the transmitted exit angle.

48. The display module as recited in claim 46, wherein the first surface of the transflector body is substantially planar.

49. The display module as recited in claim 46, wherein each first facet makes a first angle and each second facet makes a second angle with respect to a normal to the first surface and absolute values of the first and second angles are from about 22° to about 42°.

50. The display module as recited in claim 46, wherein absolute values of the reflected and transmitted viewing angles are from about 0 degrees to about 20 degrees with respect to an axis normal to the first surface.

51. The display module as recited in claim 46, wherein absolute value of the transmitted incident angle is from about 100 to about 120 degrees.

52. The display module as recited in claim 46, wherein absolute value of the reflected incident angle is from about 20 to about 40 degrees.

53. The display module as recited in claim 46, wherein the second surface of the transflector comprises prismatic structures having curved facets.

54. The display module as recited in claim 46, wherein the transflector body comprises a volume diffuser.

55. The display module as recited in claim 46, further comprising a layer of diffuse material disposed on the first surface of the transflector body.

56. The display module as recited in claim 46, wherein at least one of the surfaces of the transflector body is roughened.

57. The display module as recited in claim 46, wherein the second surface comprises a pattern of structural variations.

58. The display module as recited in claim 46, wherein the second surface comprises prismatic structures of different average heights.

59. The display module as recited in claim 46, further comprising a substrate attached to the first surface.

60. The display module as recited in claim 59, wherein the substrate comprises at least one of: a reflective polarizer, an absorbing polarizer, and a diffuser.

61. The display module as recited in claim 46, wherein the transflector is attached to the transmissive image-forming device.

62. The display module as recited in claim 61, wherein the transmissive image-forming device comprises a liquid crystal panel disposed between two polarizers and wherein the transflector is attached to an adjacent polarizer.

63. The display module as recited in claim 62, wherein the transflector is attached to the adjacent polarizer using a diffuse adhesive.

64. The display module as recited in claim 46, wherein the backlight comprises a light source, a lightguide optically connected to the light source and a back reflector.

65. The display module as recited in claim 64, wherein the lightguide is generally wedge-shaped with a thickness gradually tapering in a direction away from the light source.

66. A display module comprising:
a transmissive image-forming device,
a backlight, and
a transflector having a body, the body having a first surface and a second surface, the second surface being a structured surface that comprises a plurality of prismatic structures having a first facet and a second facet, each first facet making a first angle and each second facet making a second facet with respect to a normal to the first surface, and absolute values of the first angles being different from absolute values of the first angles; said transflector disposed between the image-forming device and the backlight so that the first surface faces the image-forming device and the second surface faces the backlight;
wherein, in a reflective mode, light transmitted through the image-forming device at and incident onto the first surface at a reflected incident angle is refracted through the first surface, reflected at the first facet of a first prismatic structure, reflected at the second facet of a second prismatic structure, refracted through the first surface, and transmitted through the image-forming device with a maximum intensity at about a reflected exit angle, and
in a transmissive mode, light originating from the backlight and incident onto the second surface at a transmitted incident angle is directed by a prismatic structure to the first surface, refracted through the first surface, and transmitted through the image-forming device with a maximum intensity at about a transmitted angle.

67. The display module as recited in claim 66, wherein the reflected exit angle is about the same as the transmitted exit angle.

68. The display module as recited in claim 66, wherein the first surface of the transflector body is substantially planar.

69. The display module as recited in claim 66, wherein absolute values of the first and second angles are from about 22° to about 42°.

70. The display module as recited in claim 66, wherein absolute values of the reflected and transmitted viewing angles are from about 0 degrees to about 20 degrees with respect to an axis normal to the first surface.

71. The display module as recited in claim 66, wherein absolute value of the transmitted incident angle is from about 100 to about 120 degrees.

72. The display module as recited in claim 66, wherein absolute value of the reflected incident angle is from about 20 to about 40 degrees.

73. The display module as recited in claim 66, wherein the second surface of the transflector comprises prismatic structures having curved facets.

74. The display module as recited in claim 66, wherein the transflector body comprises a volume diffuser.

75. The display module as recited in claim 66, further comprising a layer of diffuse material disposed on the first surface of the transflector body.

76. The display module as recited in claim 66, wherein at least one of the surfaces of the transflector body is roughened.

77. The display module as recited in claim 66, wherein the second surface comprises a pattern of structural variations.

78. The display module as recited in claim 66, wherein the second surface comprises prismatic structures of different average heights.

79. The display module as recited in claim 66, further comprising a substrate attached to the first surface.

80. The transflector as recited in claim 79, wherein the substrate comprises at least one of: a reflective polarizer, an absorbing polarizer, and a diffuser.

81. The display module as recited in claim 66, wherein the transflector is attached to the transmissive image-forming device.

82. The display module as recited in claim 81, wherein the transmissive image-forming device comprises a liquid crystal panel disposed between two polarizers and wherein the transflector is attached to an adjacent polarizer.

83. The display module as recited in claim 82, wherein the transflector is attached to the adjacent polarizer using a diffuse adhesive.

84. The display module as recited in claim 66, wherein the backlight comprises a light source, a lightguide optically connected to the light source and a back reflector.

85. The display module as recited in claim 84, wherein the lightguide is generally wedge-shaped with a thickness gradually tapering in a direction away from the light source.

86. A display module comprising:
a transmissive image-forming device,
a backlight, and
a transflector having a body, the body having a refractive index, a first surface and a second surface, the second surface being a structured surface that comprises a plurality of prismatic structures having a first facet and a second facet, each first facet making a first angle and each second facet making a second facet with respect to a normal to the first surface, said transflector disposed between the image-forming device and the backlight so that the first surface faces the image-forming device and the second surface faces the backlight;
wherein the refractive index, the first angles and the second angles of the transflector body are configured for transflective operation characterized by a transmitted exit angle and a reflected exit angle, so that
in a reflective mode, light transmitted through the image-forming device at and incident onto the first surface at a reflected incident angle is refracted through the first surface, reflected at the first facet of a first prismatic structure, reflected at the second facet of a second prismatic structure, refracted through the first surface, and transmitted through the image-forming device with a maximum intensity at about the reflected exit angle, and
in a transmissive mode, light originating from the backlight and incident onto the second surface at a transmitted incident angle is directed by a prismatic structure to the first surface, refracted through the first surface, and transmitted through the image-forming device with a maximum intensity at about the transmitted angle.

87. The display module as recited in claim 86, wherein the reflected exit angle is about the same as the transmitted exit angle.

88. The display module as recited in claim 86, wherein the first surface of the transflector body is substantially planar.

89. The display module as recited in claim 86, wherein absolute values of the first and second angles are from about 22° to about 42°.

90. The display module as recited in claim 86, wherein absolute values of the reflected and transmitted viewing angles are from about 0 degrees to about 20 degrees with respect to an axis normal to the first surface.

91. The display module as recited in claim 86, wherein absolute value of the transmitted incident angle is from about 100 to about 120 degrees.

92. The display module as recited in claim 86, wherein absolute value of the reflected incident angle is from about 20 to about 40 degrees.

93. The display module as recited in claim 86, wherein the second surface of the transflector comprises prismatic structures having curved facets.

94. The display module as recited in claim 86, wherein the transflector body comprises a volume diffuser.

95. The display module as recited in claim 86, further comprising a layer of diffuse material disposed on the first surface of the transflector body.

96. The display module as recited in claim 86, wherein at least one of the surfaces of the transflector body is roughened.

97. The display module as recited in claim 86, wherein the second surface comprises a pattern of structural variations.

98. The display module as recited in claim 86, wherein the second surface comprises prismatic structures of different average heights.

99. The display module as recited in claim 86, further comprising a substrate attached to the first surface.

100. The transflector as recited in claim 99, wherein the substrate comprises at least one of: a reflective polarizer, an absorbing polarizer, and a diffuser.

101. The display module as recited in claim 86, wherein the transflector is attached to the transmissive image-forming device.

102. The display module as recited in claim 101, wherein the transmissive image-forming device comprises a liquid crystal panel disposed between two polarizers and wherein the transflector is attached to an adjacent polarizer.

103. The display module as recited in claim 102, wherein the transflector is attached to the adjacent polarizer using a diffuse adhesive.

104. The display module as recited in claim 86, wherein the backlight comprises a light source, a lightguide optically connected to the light source and a back reflector.

105. The display module as recited in claim 104, wherein the lightguide is generally wedge-shaped with a thickness gradually tapering in a direction away from the light source.

106. A method of making a transflector, comprising the steps of:
selecting a reflected incident angle;
selecting a transmitted incident angle;
selecting a reflected exit angle;
selecting a transmitted exit angle; and
configuring a transflector body having a first surface and a second surface, the second surface being a structured surface comprising a plurality of prismatic structures, so that
in a reflective mode, light incident onto the first surface at the reflected incident angle is refracted through the first surface to a first prismatic structure, directed by the first prismatic structure to a second prismatic structure, directed by the second prismatic structure to the first surface, and refracted through the first surface with a maximum intensity at about the reflected exit angle; and
in a transmissive mode, light incident onto the second surface at the transmitted incident angle is directed by a prismatic structure to the first surface and refracted through the first surface with a maximum intensity at about the transmitted exit angle.

107. The method of claim 106, wherein the transmitted exit angle is selected to be about the same as the reflected exit angle.

108. The method of claim 106, wherein the first surface is selected to be substantially planar.

109. A method of making a transflector, comprising the steps of:
selecting a reflected incident angle;
selecting a transmitted incident angle;
selecting a reflected exit angle;
selecting a transmitted exit angle; and
configuring a transflector body having a refractive index, a substantially planar surface and a structured surface comprising a plurality of prismatic structures having a first facet and a second facet, each first facet making a first angle and each second facet making a second angle with respect to a normal to the substantially planar surface, so that
in a reflective mode, light incident onto the substantially planar surface at the reflected incident angle is refracted through the substantially planar surface, reflected at the first facet of a first prismatic structure, reflected at the second facet of a second prismatic structure, and refracted through the substantially planar surface with a maximum intensity at about the reflected exit angle, and,
in a transmissive mode, light incident onto the structured surface at the transmitted incident angle is directed by a prismatic structure to the substantially planar surface and is refracted through the substantially planar surface with a maximum intensity at about the transmitted exit angle.

110. The method of claim 109, wherein the transmitted exit angle is selected to be substantially the same as the reflected exit angle.
